(19) United States
(12) Patent Application Publication
(10) Pub. No.: US 2008/0295456 A1
(43) Pub. Date: Dec. 4, 2008

(54) BUSINESS METHODS FOR DISTRIBUTION OF TRANSPARENT CONDUCTIVE CARBON FILMS

(75) Inventors: John Miller, Pasadena, CA (US); Shripal Gandhi, Palo Alto, CA (US)

Correspondence Address: UNIDYM, 201 SOUTH LAKE AVE., SUITE 703, PASADENA, CA, 91101, US

(73) Assignee: UNIDYM, INC., Pasadena, CA (US)

(21) Appl. No.: 11/678,387

(22) Filed: Feb. 23, 2007

(51) Int. Cl. B65B 11/52; B05D 5/12

(52) U.S. Cl. 53/427; 427/122

(57) ABSTRACT

A system and business method for maximizing the fabrication and distribution efficiency of transparent conductive carbon films, while at the same time preserving the desirable mechanical, electrical and optical properties of the films, are discussed. This system and method preferably employ a roll-to-roll fabrication process, environmental controls, testing of pertinent optoelectronic properties and packaging.

### FIELD OF THE INVENTION

The present invention relates in general to distribution methods, and more particularly to a business method for distributing transparent conductive carbon films.

### BACKGROUND

Many modern and/or emerging applications require at least one device electrode that has not only high electrical conductivity, but high optical transparency as well. Such applications include, but are not limited to, touch screens (e.g., analog, resistive, improved analog, X/Y matrix, capacitive), flexible displays (e.g., electro-phoretics, electro-luminescence, electrochromatic), rigid displays (e.g., liquid crystal (LCD), plasma (PDP), organic light emitting diode (LED)), solar cells (e.g., silicon (amorphous, protocrystalline, nanocrystalline), cadmium telluride (CdTe), copper indium gallium selenide (CIGS), copper indium selenide (CIS), gallium arsenide (GaAs), light absorbing dyes, quantum dots, organic semiconductors (e.g., polymers, small-molecule compounds)), fiber-optic communications (e.g., electro-optic and opto-electric modulators) and microfluidics (e.g. electrowetting on dielectric (EWOD)).

Currently, the most common transparent electrodes are transparent conducting oxides (TCOs), specifically indium-tin-oxide (ITO) on glass. However, ITO can be an inadequate solution for many of the above-mentioned applications (e.g., due to its relatively brittle nature and correspondingly inferior flexibility and abrasion resistance), plus the indium component of ITO is rapidly becoming a scarce commodity. Additionally, ITO deposition usually requires expensive, high-temperature sputtering, which can be incompatible with many device process flows. Hence, more robust and abundant transparent conductors are being explored.

Transparent conductive carbon films (e.g., as disclosed in PCT Application No. PCT/US2005/047315 filed Dec. 27, 2005, the entire contents of which are incorporated herein by reference) have been demonstrated as having better mechanical properties than ITO, with comparable electrical and optical properties. Moreover, such films can be deposited using relatively inexpensive, solution-based roll-to-roll processes, and carbon is one of the most abundant elements on Earth. Unfortunately, these films have also demonstrated greater susceptibility to environmental effects than ITO films. Consequently, new methods are required to take commercial advantage of the technical benefits that transparent conductive carbon films offer.

### SUMMARY OF INVENTION

A business method according to preferred embodiment of the present invention comprises efficiently fabricating, packaging, storing and/or shipping a transparent conductive carbon film such that environmental effects are substantially reduced, and throughput is optimized. The novelty of this method stems largely from unprecedented industry need—to date no company is commercially distributing rolls of transparent conductive carbon film, and comparable commercial products (e.g., ITO films) have very different distribution requirements.

Transparent conductive carbon films according to embodiments of the present invention may have optical transparencies of at least 80% and electrical sheet resistances of less than 1000 ohms, and are preferably deposited onto substrate using a roll-to-roll apparatus, such that a roll of carbon-coated substrate is produced. As compared to a batch process, which handles only one component at a time, a roll-to-roll process represents a dramatic deviation from current manufacturing practices, and can reduce capital equipment and display part costs, while significantly increasing throughput. The substrate may be flexible and transparent, with a thickness of 100-200 microns, or less. This substrate is preferably rolled around a core having less than a 6″ inner diameter with the carbon-coated surface wrapped inside (preferred core diameter ranges from 1″ to 5″ for a balance of film-bearing capacity and ease of handling) to form a roll.

This roll may further be packaged with a protective (e.g., plastic) cover and/or fixed in mid-air suspension plates. Given carbon films' general sensitivities to environmental effects such as moisture and temperature, this plastic wrapping is preferably sealed and relatively air-tight. Additionally or alternatively, a desiccant may be used to control the ambient humidity around the carbon film (e.g., desiccant bags, desiccant canisters, desiccant units), preferably maintaining a relative humidity of less than 35% around the film. This desiccant may be packaged within the plastic wrapping, interspersed between layers of carbon-coated substrate and/or dispersed in the surrounding area.

In further embodiments of the present invention, an encapsulant may be coated over the carbon film to further reduce environmental effects attributable to humidity, abrasion, adhesion and atmospheric gases. The passivation material may be, for example, a fluorine-based polymer encapsulant integrated as a topcoat and/or composite with the carbon film. If this and/or a similar material(s) are used, yet a further embodiment of the present invention may comprise hazardous material handling precautions. Such precautions may entail filing appropriate hazardous material forms and selecting packaging to effectively contain the potentially toxic materials.

Environmental effects may be further reduced by employing temperature and/or relative humidity control in an ambient storage environment around the roll.

Still further embodiments of the present invention may comprise testing the optoelectronic properties of the transparent conductive carbon film prior to packaging the roll. The results of such testing may be affixed to the corresponding roll on a label, along with specifications, predicted performance and/or shipping and handling instructions.

Other features and advantages of the invention will be apparent from the accompanying drawings and from the detailed description. One or more of the above-disclosed embodiments, in addition to certain alternatives, are provided in further detail below with reference to the attached figures. The invention is not limited to any particular embodiment disclosed.

### BRIEF DESCRIPTION OF THE DRAWINGS

The invention is better understood from reading the following detailed description of the preferred embodiments, with reference to the accompanying figures in which:

FIG. 1 is an atomic force microscope (AFM) image of a transparent conductive carbon film according to embodiments of the present invention;

FIG. 2 is a schematic representation of a transparent conductive carbon film deposition method according to further embodiments of the present invention, specifically wherein a roll-to-roll apparatus is used; and

FIG. 3 is a graph of normalized resistance versus time, highlighting the susceptibility of transparent conductive carbon films according to embodiments of the present invention to environmental conditions such as temperature and relative humidity.

Features, elements, and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

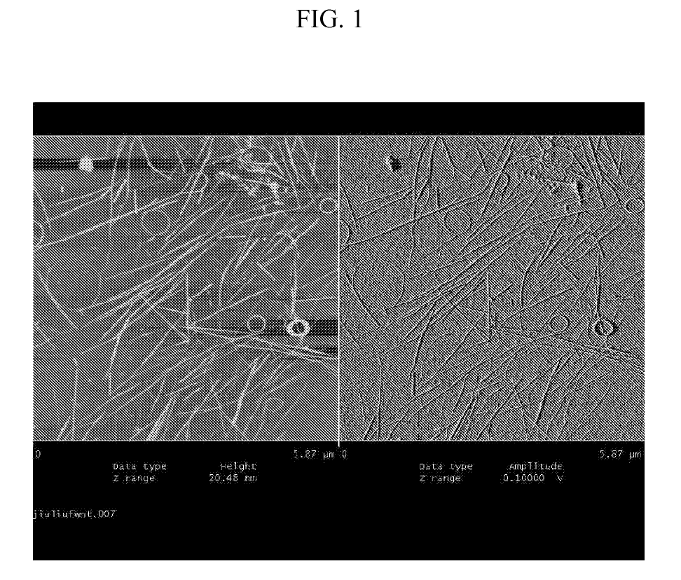

Referring to FIG. 1, a business method according to a preferred embodiment of the present invention comprises first depositing a transparent conductive carbon film (e.g., as depicted in FIG. 1) onto a transparent flexible substrate using a solution-based deposition method (e.g., spray-coating, dip-coating, drop-coating and/or casting, roll-coating, micro-gravure printing, slot-die coating, transfer-stamping and/or inkjet printing). As used herein, a film is said to be “transparent” when the layer or layers permit at least 50% of the ambient electromagnetic radiation in relevant wavelengths to be transmitted through the layer or layers. Similarly, a film is said to be “conductive” if the density of electrically conductive elements therein is above a percolation threshold. Preferably, transparent conductive carbon films according to embodiments of the present invention have optical transmissions of at least 80% and electrical sheet resistances of less than 1000 ohms.

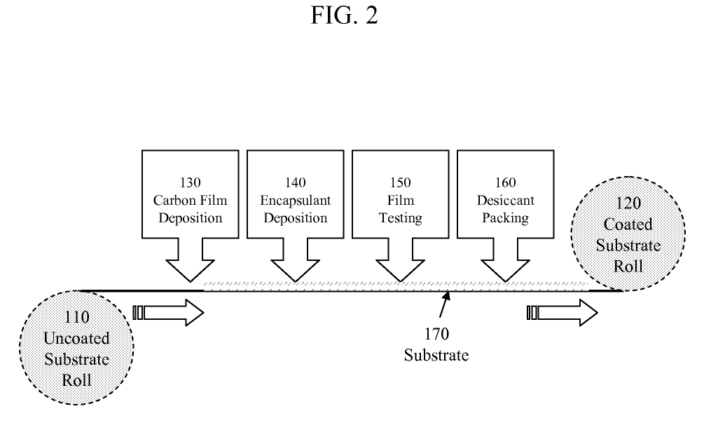

Referring to FIG. 2, preferably a transparent conductive carbon film fabrication method according to embodiments of the present invention utilizes a roll-to-roll process. As compared to a batch process, which handles only one component at a time, a roll-to-roll process represents a dramatic deviation from current manufacturing practices that can reduce capital equipment and display part costs, while significantly increasing throughput. Such a process generally requires use of a flexible substrate, which is preferably transparent, and may comprise, for example, plastics such as polyethylene terephthalate (PET), polyethylene naphthalate (PEN), polycarbonate (PC), polyethersulfone (PES) and/or Arton. An exemplary roll-to-roll process comprises at least two rolls and a coater, wherein one roll supports uncoated substrate and feeds into the coater, while a second roll supports carbon-coated substrate extracted from the coater. In a preferred embodiment of the present invention, the second roll comprises a carbon-coated film wound onto a core having an inner diameter of less than 6″, with the carbon-coated surface preferably inside.

The novelty of the present invention stems largely from unprecedented industry need—to date, no company is commercially distributing rolls of transparent conductive carbon films (such materials are produced/distributed only on a small sample scale), and comparable commercial products, specifically industry-standard indium tin oxide (ITO), possess very different fabrication, storage and/or transportation requirements. Specifically, in contrast to the above aspect of the present invention, transparent conductive ITO films coated on a flexible substrate must generally be wound on cores having an at least 6″ diameter because of ITO's brittle nature; bending the ITO-film at a tighter radius than such specification risks cracking of the ITO layer and subsequent degradation of its electrical properties, mechanical properties and appearance. Flex cycling tests indicate that ITO samples undergo a greater than 2% change after only 1,000 cycles, with corresponding undesirable increases in sheet resistance between 200˜1,000 cycles that were more than ten times larger than found in, e.g., a transparent conductive carbon film throughout 2,500 cycles. Such marked increases in sheet resistance (i.e., decreases in optoelectronic performance) were largely attributable to cracks in the ITO film, which continued to grow as flex cycling continued until ultimately leading to catastrophic failure (e.g., open circuit). Others have reported the onset of cracks in a transparent conductive ITO film at approximately 1.5-2.5% tensile strain, with catastrophic failure at less than 5% tensile strain and corresponding increases in sheet resistance of over 20,000%. Such mechanical shortcomings pose severe limitations in the context of not only device applications (e.g., flexible displays), but large-scale film fabrication (e.g., roll-to-roll) and distribution as well.

Such a failure mechanism is not generally observed in transparent conductive carbon films deposited on flexible substrates, as according to the present invention. Flex cycling of carbon nanotube coating showed a less than 0.5% change in resistance after 2,500 cycles. Moreover, experiments have shown that transparent conductive carbon films can be bent to radii of as little as 7.5 millimeters without a significant loss in performance. Consequently, transparent conductive carbon films according to embodiments of the present invention can and are preferably wrapped on less-than-6″ cores, such that the films can be more efficiently distributed than conventional ITO films; ˜1″ cores are preferred for ease of handling. Using industry standard half-meter-web rolls, 1″ cores provide an additional capacity of almost 25 square meters of film over conventional 6″ cores.

Shipping capacity and efficiency can be further increased by using thinner flexible substrates than are used with conventional ITO films. Transparent conductive carbon films according to embodiments of the present invention are extremely thin (˜10⁻⁸ m), thus the bulk of the final product (i.e., substrate plus carbon film) thickness and weight is attributable to the substrate (˜200 microns). As mentioned above, ITO deposition generally requires high-temperature sputtering processes, necessitating relatively thick underlying substrates (i.e., to withstand the relatively harsh deposition conditions), even where a cold drum is used. On the other hand, transparent conductive carbon films according to preferred embodiments of the present invention are deposited using relatively low-temperature solution-based methods, allowing for the use of thinner substrates (˜25 microns) and corresponding increases in capacity.

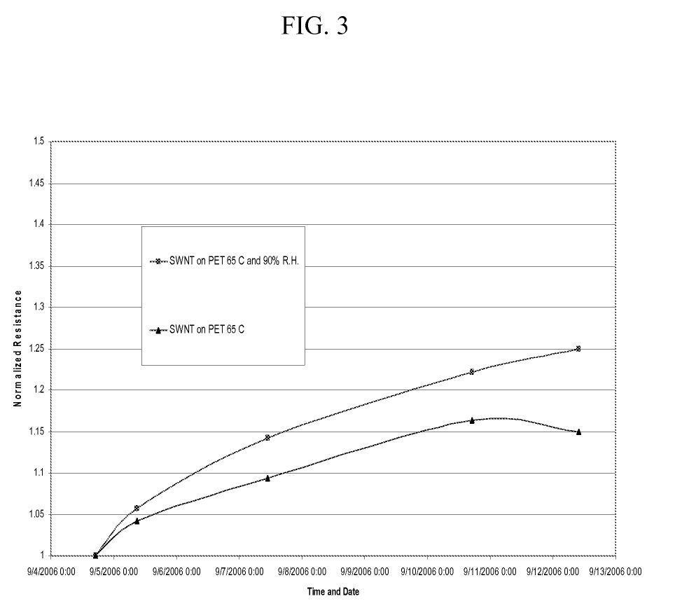

Referring to FIG. 3, although transparent conductive carbon films according to embodiments of the present invention generally have superior mechanical properties to conventional ITO films, transparent conductive carbon films are typically much more susceptible to environmental effects than transparent conductive ITO films. Experimental data showed that a transparent conductive carbon film (comprising SWNTs) deposited on a transparent flexible substrate (polyethylene (PET)) suffered an approximately 25% increase in sheet resistance over only eight days when exposed to 90% relative humidity (R.H.) in a 65° C. oven. A similar performance drop is not observed in otherwise optoelectronically comparable ITO films, which generally display a less than 10% increase in sheet resistance under such environmental conditions, this increase usually being only temporary and largely self-recoverable upon removal of the environmental conditions.

For such reasons, a business method according to additional embodiments of the present invention comprises novel steps taken to maintain less degrading local and ambient environments around transparent conductive carbon films, specifically with respect to R.H. and temperature.

A first level of protection from environmental effects, according to a preferred embodiment of the present invention, comprises packaging the above carbon-coated substrate rolls. For example, once a substrate is wound onto a roll and labeled, the roll is preferably wrapped in plastic film, with excess plastic tucked into the core such that the wrapping is relatively air tight. Additionally, the roll may be fixed in mid-air suspension plates and packed in double-walled carton boxes, for ease of handling.

A second level of protection according to a preferred embodiment of the present invention comprises packaging at least one desiccant within the plastic wrapping and/or in the box (e.g., such that the R.H. is maintained below 35%; preferably below 20%). For example, desiccants may be inserted prior to the rolling process, such that they are interspersed between adjacent layers. Applicable desiccant materials include, but are not limited to, silica gels, clay desiccants, calcium oxide and calcium sulfate. Because of ITO's relatively-high environmental stability, use of desiccants during shipping and storage was not essential in the prior art. Even where devices incorporating ITO films were shipped with desiccants, such desiccants were typically employed to protect device active layers rather than the transparent conductive layers.

A third level of protection according to a preferred embodiment of the present invention comprises temperature and R.H. control in the ambient storage/shipping environment. As is evident from FIG. 3, carbon film sheet resistance can increase substantially even in the absence of relative humidity, i.e., due solely to high temperature. Ambient temperature and R.H. control can be especially applicable where different application-specific top-coats and/or encapsulants will be added post-shipping.

A fourth level of protection according to a preferred embodiment of the present invention comprises depositing an encapsulant material on the transparent conductive carbon film. Encapsulant materials may be deposited before the rolling process, such that an encapsulated transparent conductive carbon film is rolled-up and shipped. Additionally or alternatively, encapsulant materials may be deposited post-shipping (e.g., where application-specific encapsulant materials are used). Exemplary encapsulant materials include, but are not limited to, fluoropolymers, polyesters, silicons, acrylics and melamines.

If these and/or similar materials are used, yet a further embodiment of the present invention may comprise hazardous material handling precautions. Such precautions may entail filing appropriate hazardous material forms and selecting packaging to contain the potentially toxic materials.

Still further embodiments of the present invention comprise testing transparent conductive carbon films to ensure quality control prior to or during the rolling process. Key factors for such films include, but are not limited to, uniformity, sheet resistance, transparency, haze, resistance across and along the web, transmission across and along the web, and minimum color along the web.

Test results are preferably included on a roll label affixed to an outer surface of the carbon-coated substrate roll, along with other pertinent information. For example, roll labels may identify the following: part number, product type, lot number and roll identification, supplier roll number, substrate supplier roll number (when available), width and length of the roll, gauge of the substrate, the side of the roll that is coated with ITO and/or a description indicating the amount of good material in the roll. Additionally, the label may include performance predictions (e.g., based on test results and environmental degradation data), handling and storage information. For example, rolls of transparent conductive carbon film should generally be handled only by the cores, and should be stored by suspending the rolls by the core, since touching the film (especially with bare hands) can cause deterioration, due to exposure to oils and salts; use of latex or nylon gloves for handling is also recommended for this reason. The rolls may also be labeled with a warranted shelf life (e.g., six (6) months after delivery from the factory, when stored indoors between 15 C and 30 C and <60% RH and by the methods specified above).

Such labels are preferably placed inside of the core, such that they are visible at the inner edge of the end plug. Additionally or alternatively, such labels may be placed outside a plastic wrapping on the roll (see below) and/or on an outside surface of a carton box in which the roll is stored (see below). In addition to labels affixed to the roll itself, a Certificate of Quality may be provided for each product roll.

The present invention has been described above with reference to preferred features and embodiments. Those skilled in the art will recognize, however, that changes and modifications may be made in these preferred embodiments without departing from the scope of the present invention. These and various other adaptations and combinations of the embodiments disclosed are within the scope of the invention.

What is claimed is:

1. A method of distributing a transparent conductive carbon film, comprising:
depositing a transparent conductive carbon film on a substrate; and
rolling the substrate onto a core to form a roll, wherein the substrate is transparent and flexible.

2. The method of claim 1, wherein the core has a diameter of less than 6 inches.

3. The method of claim 2, wherein the transparent conductive carbon film is deposited on the substrate with a roll-to-roll apparatus.

4. The method of claim 3, wherein the substrate has a thickness of less than 200 microns.

5. The method of claim 4, further comprising packaging the roll with a desiccant, wherein the desiccant maintains a relative humidity of less than 35% around the roll.

6. The method of claim 5, further comprising packaging the roll in a protective cover, wherein the protective cover is substantially air-tight.

7. The method of claim 6, further comprising controlling at least one of ambient temperature and ambient relative humidity around the roll.

8. The method of claim 7, further comprising depositing an encapsulant on the transparent conductive carbon film.

9. The method of claim 8, further comprising testing optoelectronic properties of the transparent conductive carbon film prior to packaging the roll.

10. The method of claim 9, further comprising labeling the roll to include at least one of specifications, testing results, predicted performance and shipping and handling instructions.

11. The method of claim 1, wherein the substrate has a thickness of less than 100 microns.

12. The method of claim 1, wherein the core has a diameter of between 1 to 5 inches.

13. The method of claim 1, wherein the core has a diameter of less than about 1 inch.

14. The method of claim 1, further comprising depositing an encapsulant on the transparent conductive carbon film.

15. The method of claim 1, wherein the transparent conductive carbon film has an optical transparency of at least 80% and an electrical sheet resistance of less than 1000 ohms.

16. A method of fabricating a transparent electrode, comprising:
depositing a transparent conductive carbon film on a substrate; and
rolling the substrate onto a core to form a roll, wherein the substrate is transparent and flexible, and
wherein the core has a diameter of less than 6 inches.

17. The method of claim 16, wherein the core has a diameter between 1 to 3 inches.

18. The method of claim 16, wherein the substrate has a thickness of less than 100 microns.

19. A method of storing a roll of transparent conductive carbon film, comprising:
packing the roll of transparent conductive carbon film in a plastic cover; and
inserting desiccant within the plastic cover, wherein the desiccant reduces the relative humidity within the plastic cover to below 35%.

20. The method of claim 19, wherein the desiccant is interspersed between layers of substrate in the roll of transparent conductive carbon film, and
wherein the plastic cover is substantially air-tight.
